(19) United States
(12) Patent Application Publication
(10) Pub. No.: US 2024/0372281 A1
(43) Pub. Date: Nov. 7, 2024

(54) ELECTRICAL CONTACT MATERIAL, AND CONTACT, TERMINAL AND CONNECTOR MADE USING THIS

(71) Applicants: FURUKAWA ELECTRIC CO., LTD., Tokyo (JP); FURUKAWA AUTOMOTIVE SYSTEMS INC., Inukami-gun (JP)

(72) Inventors: Yoshitane TORII, Tokyo (JP); Shuichi KITAGAWA, Tokyo (JP); Soki KUZUHARA, Tokyo (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 18/579,915

(22) PCT Filed: Mar. 10, 2023
(86) PCT No.: PCT/JP2023/009300

§ 371 Date: Jan. 17, 2024

(30) Foreign Application Priority Data
Mar. 30, 2022 (JP) 2022-055028

(51) Int. Cl. H01R 13/03; H01B 1/02

(52) U.S. Cl. CPC H01R 13/03; H01B 1/02

(57) ABSTRACT

An electrical contact material includes an electroconductive substrate, and a silver-containing layer including silver provided to at least part of a surface of the electroconductive substrate. An average CI value of the silver-containing layer is 0.6 or more in a cross section of the electrical contact material.

### TECHNICAL FIELD

The present disclosure relates to an electrical contact material, and a contact, terminal and connector made using this.

### BACKGROUND ART

In the recent years, in order to achieve fuel savings in automobiles, electrification of the vehicle drive systems has progressed. Accompanying the electrification of the vehicle drive systems, the amount of electrical current in wires between the battery, inverter and motor dramatically increases, while the heat generation at contacts and connectors during the flow of current becomes a problem. For this reason, a material made by conducting nickel base plating on the surface of a high conductivity pure copper, dilute copper alloy or corson alloy, and further conducting silver plating or silver alloy plating on the base plating has been used in the contacts and the connectors. However, since silver is a metal species which is prone to adhesive wear, the silver plating tends to be shaved off when sliding. For this reason, there has been a deficiency in that the contact resistance of the silver plating material will rise from wearing of the silver plating.

Addressing such a deficiency, for example, Patent Document 1 discloses a silver-plated terminal for connectors in which the surface of the base material consisting of copper or copper alloy is covered by a silver plating layer, the silver plating layer consists of a first silver plating layer on a lower layer side and a second silver plating layer on the upper layer side of the first silver plating layer, and the crystal grain size of the first silver plating layer is greater than the crystal grain size of the second silver plating layer. To address the problem in the silver plating material of the crystal grain size of the silver plating layer tending to increase by recrystallization, hardness lowering from the increase in this crystal grain size, and the wear resistance declining, Patent Document 1 defines the size of the crystal grain size of the silver plating layer as a material with good wear resistance. However, the size of the crystal grain size depends on the thickness of the plating layer. For this reason, to obtain favorable wear resistance, Patent Document 1 limits the thickness of the silver plating layer.

In addition, Patent Document 2 discloses a production method of a silver plating material which forms a silver plated film with 99.9% by mass or more purity on a substrate as a material, by performing electroplating so that y and x become a predetermined relationship, with y being the product of the concentration of potassium cyanide in the silver plating solution and the current density, and x being the solution temperature, in a silver plating solution containing a predetermined concentration of silver and potassium cyanide. Patent Document 2 exemplifies a production method of a silver plating material made to suppress an increase in contact resistance while maintaining high hardness, by containing elements such as selenium in the silver plating film, and the Vicars hardness of the silver plating material surface is the basis for wear resistance. In this way, Patent Document 2 uses, in the evaluation of wear resistance, the Vicars hardness of the silver plating material which depends on the properties of the substrate. However, originally, it is necessary to evaluate the wear resistance of the plated film itself hardly influenced by the substrate properties.

### CITATION LIST

### Patent Document

Patent Document 1: Japanese Unexamined Patent Application, Publication No. 2008-169408
Patent Document 2: Japanese Patent No. 6611602

### DISCLOSURE OF THE INVENTION

### Problems to be Solved by the Invention

The object of the present disclosure is to provide an electrical contact material having superior wear resistance which is hardly influenced by the substrate properties, as well as a contact, terminal and connector made using this.

### Means for Solving the Problems

[1] An electrical contact material includes: an electroconductive substrate; and a silver-containing layer including silver provided to at least part of a surface of the electroconductive substrate, in which an average CI value of the silver-containing layer is 0.6 or more in a cross section of the electrical contact material.

[2] In the electrical contact material according to [1] above, an average IQ value of the silver-containing layer is 1000 or more and 2100 or less in the cross section of the electrical contact material.

[3] In the electrical contact material according to [1] or [2] above, the silver-containing layer includes at least one element selected from the group consisting of Sn, Zn, In, Ni, Cu, Se, Sb and Co.

[4] In the electrical contact material according to any one of [1] to [3] above, the silver-containing layer includes a total of less than 15.0 at % of at least one element selected from the group consisting of Sn, Zn, In, Ni, Cu, Se, Sb and Co.

[5] In the electrical contact material according to any one of [1] to [4] above, an average thickness of the silver-containing layer is 0.5 μm or more and 5.0 μm or less.

[6] In the electrical contact material according to any one of [1] to [5] above, the electrical contact material further includes an intermediate layer consisting of nickel or nickel alloy between the electroconductive substrate and the silver-containing layer.

[7] In the electrical contact material according to [6] above, an average thickness of the intermediate layer is 0.01 μm or more and 3.00 μm or less.

[8] A contact is made using the electrical contact material according to any one of [1] to [7] above.

[9] A terminal is made using the electrical contact material according to any one of [1] to [7] above.

[10] A connector is made using the electrical contact material according to any one of [1] to [7] above.

### Effects of the Invention

According to the present disclosure, it is possible to provide an electrical contact material having superior wear resistance which is hardly influenced by the substrate properties, as well as a contact, terminal and connector made using this.

### BRIEF DESCRIPTION OF THE DRAWINGS

FIG. 1 is a cross-sectional view showing an example of an electrical contact material according to an embodiment.

FIG. 2 is a cross-sectional view showing another example of an electrical contact material according to an embodiment.

### PREFERRED MODE FOR CARRYING OUT THE INVENTION

The details will be explained below based on an embodiment.

The present inventors focused on the strain amount in a silver-containing layer provided to at least part of the surface of an electroconductive substrate, and found, as a result of extensive research, that by controlling the CI value of the silver-containing layer, the wear resistance of the electrical contact material was superior independently of the properties of the electroconductive substrate, and based on such knowledge, arrived at completing the present disclosure.

The electrical contact material according to the embodiment includes an electroconductive substrate, and a silver-containing layer including silver provided to at least part of a surface of the electroconductive substrate, in which an average CI value of the silver-containing layer is 0.6 or more in a cross section of the electrical contact material.

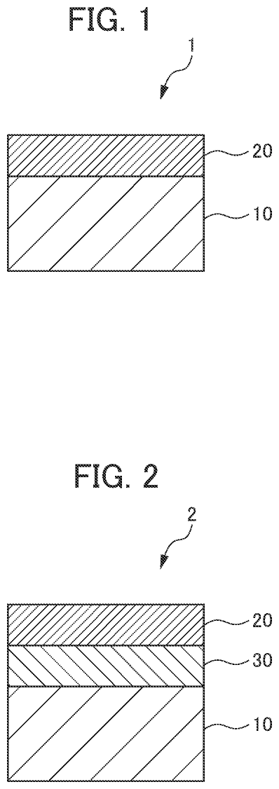

FIG. 1 is a cross-sectional view showing an example of an electrical contact material according to an embodiment. As shown in FIG. 1, an electrical contact material 1 includes an electroconductive substrate 10 and a silver-containing layer 20.

The electroconductive substrate 10 constituting the electrical contact material 1 is a rolled material having electrical conductivity, and is obtained by a rolling process. From the viewpoint of the rolling processability of the electroconductive substrate 10 and high electroconductivity of the electrical contact material 1, the electroconductive substrate 10 is preferably made from a copper-based material containing pure copper and copper alloy, or an iron-based material containing pure iron and iron alloy. Thereamong, it is preferably a copper alloy based on Cu—Zn, Cu—Ni—Si, Cu—Sn—Ni, Cu—Cr—Mg, or Cu—Ni—Si—Zn—Sn—Mg.

The electrical conductivity of the electroconductive substrate 10 is preferably 60% IACS or more, and more preferably 80% IACS or more. When the electrical conductivity of the conductivity substrate 10 is 60% IACS or more, the electrical contact material 1 has favorable electroconductivity.

The shape of the electroconductive substrate 10 may be appropriately selected according to the application of the electrical contact material 1; however, it is preferably a strip, plate, rod or wire.

The silver-containing layer 20 constituting the electrical contact material 1 is provided to at least part of the surface of the electroconductive substrate 10, and contains silver. The silver-containing layer 20 covering the surface of the electroconductive substrate 10 consists of pure silver or silver alloy, and preferably consists of silver alloy, i.e. the silver-containing layer 20 is a silver alloy layer. From the viewpoint of the electrical contact material 1 having superior wear resistance, and the wear resistance of the electrical contact material 1 hardly being influenced by the properties of the electroconductive substrate 10, the silver-containing layer 20 is preferably formed by plating, i.e. the silver-containing layer 20 is preferably a plated film.

In the cross section of the electrical contact material 1 shown in FIG. 1, the average CI value of the silver-containing layer 20 is 0.6 or more. The cross section of the electrical contact material 1 is a cross section parallel to the rolling direction of the electroconductive substrate 10.

When the average CI value of the silver-containing layer 20 in the cross section of the electrical contact material 1 is 0.6 or more, since the second element makes a solid solution in the crystals of silver in the silver-containing layer 20 and the crystallinity improves, the coefficient of dynamic friction is low, and it is possible to maintain high hardness, and thus the wear resistance can be improved. The reliability of the crystal orientation is higher with a higher average CI value. From such a viewpoint, the average CI value of the silver-containing layer 20 in the cross section of the electrical contact material 1 is 0.6 or more, and is preferably higher.

In addition, the average IQ value of the silver-containing layer 20 in the cross section of the electrical contact material 1 is preferably 1000 or more, and is more preferably 1500 or more. If the average IQ value of the silver-containing layer 20 is 1000 or more, the crystal quality is favorable.

In addition, the average IQ value of the silver-containing layer 20 in the cross section of the electrical contact material 1 is preferably 2100 or less, and is more preferably 2000 or less. If the average IQ value of the silver-containing layer 20 is 2100 or less, the crystal lattice sufficiently distorts, and distortion becomes abundant, whereby it is possible to improve wear resistance.

The CI (Confidence Index) value is a value used in pattern indexing, an index for evaluating whether the calculated crystal orientation is correct, and to evaluate whether the calculated crystal orientation is correct. The CI value is a value reflecting the reliability of the crystal orientation in the silver-containing layer 20.

In addition, the IQ (Image Quality) value is a value obtained by plotting the peak intensity indicating a band on Hough space upon Hough transforming the EBSD pattern, and is a value reflecting favorability of crystallinity and distortion in the silver-containing layer 20, by the magnitude thereof.

The CI value and the IQ value can be obtained from crystal orientation analysis data calculated using analysis software (OIM Analysis produced by TSL Solutions) from the crystal orientation data measured continuously using EBSD detector (OIM 5.0 HIKARI produced by TSL Solutions) belonging to a high-resolution scanning analytical electron microscope (JSM-7001FA manufactured by JEOL Ltd.). The measurement target is the silver-containing layer 20 surface on a surface which was obtained by mirror finishing the cross section of the electrical contact material 1 parallel to the rolling direction of the electroconductive substrate 10 with the use of cross section polisher (manufactured by JEOL, Ltd.), and the measurement magnification is 30,000 times. The measurement by steps of 50 nm or less measurement intervals conducts, the measurement points at which the CI value analyzed by the analysis software is 0.1 or less are eliminated (noise reduction), the boundary at which the misorientation between adjacent pixels is 5.000 or more is regarded as the grain boundary, to obtain the CI value and the IQ value of the silver-containing layer 20. This measurement is performed a plurality of times (plurality of different measurement regions on same sample), and the average value thereof was calculated, whereby the average CI value and the average IQ value of the silver-containing layer 20 can be obtained. In this way, the average CI value and the average IQ value are respectively the average values of the CI value and the IQ value in the measurement region of the silver-containing layer measured at the magnitude of 30000 times.

In addition, the silver-containing layer 20 preferably contains at least one element (also referred to as second element hereinafter) selected from the group consisting of Sn, Zn, In, Ni, Cu, Se, Sb and Co. By having the second element coexist in the silver-containing layer 20, it is possible to improve the sliding property. Thereamong, from the viewpoint of improving the electrical connection property of the electrical contact material 1, the silver-containing layer 20 preferably contains less than 15.0 at % in total of the at least one element selected from the group consisting of Sn, Zn, In, Ni, Cu, Se, Sb and Co. In addition, from the viewpoint of an efficient improvement in slidability due to the addition of the second element and a material cost reduction, the silver-containing layer 20 preferably contains 0.1 at % or more in total of the at least one element selected from the group consisting of Sn, Zn, In, Ni, Cu, Se, Sb and Co.

The lower limit value for the average thickness of the silver-containing layer 20 is preferably 0.5 μm or more, more preferably 2.0 μm or more, and even more preferably 3.0 μm or more. The upper limit value for the average thickness of the silver-containing layer 20 is preferably 5.0 μm or less. When the lower limit value for the average thickness of the silver-containing layer 20 is 0.5 μm or more, it is possible to maintain superior wear resistance of the electrical contact material 1 over a long period. When the upper limit value for the average thickness of the silver-containing layer 20 is 5.0 μm or less, it is possible to suppress the material cost.

FIG. 2 is a cross-sectional view showing another example of an electrical contact material according to an embodiment. In the electrical contact material 2 shown in FIG. 2, other than the configuration of an intermediate layer 30 being added, it is basically the same as the configuration of the electrical contact material 1 shown in FIG. 1.

As shown in FIG. 2, the electrical contact material 2 further includes an intermediate layer 30 consisting of nickel or nickel alloy between the electroconductive substrate 10 and silver-containing layer 20. When the intermediate layer 30 is provided between the surface of the electroconductive substrate 10 and the silver-containing layer 20, it is possible to suppress the thermal diffusion of the elements constituting the electroconductive material 10 to the silver-containing layer 20, and to improve the adhesion between the electroconductive substrate 10 and the silver-containing layer 20.

From the viewpoint of further suppressing the above thermal diffusion and improving the above adhesion, the intermediate layer 30 is preferably pure nickel or a Ni—P based nickel alloy.

The lower limit value for the average thickness of the intermediate layer 30 is preferably 0.01 μm or more, more preferably 0.10 μm or more, and even more preferably 0.30 μm or more. The upper limit value for the average thickness of the intermediate layer 30 is preferably 3.00 μm or less, more preferably 2.00 μm or less, and even more preferably 1.00 μm or less. When the lower limit value for the average thickness of the intermediate layer 30 is less than 0.01 μm, it is not possible to achieve the above suppression of thermal diffusion and the above improvement in adhesion. When the upper limit value for the average thickness of the intermediate layer 30 exceeds 3.00 μm, the bending workability deteriorates. In the case of using the electrical contact material in a terminal, bending workability of R/t≥1 is demanded.

In addition, the above electrical contact materials 1, 2 may further include a copper layer (not shown) directly below the silver-containing layer 20, which is the top layer. The copper layer (not shown) is made from pure copper or copper alloy. Compared to the thickness of the electroconductive substrate 10, the thickness of the copper layer (not shown) is much smaller. When the electrical contact material 1, 2 further includes the copper layer (not shown) provided directly under the silver-containing layer 20, it is possible to improve adhesion and bending workability.

In the above way, since the electrical contact material 1, 2 has superior wear resistance which is hardly influenced by the properties of the electroconductive substrate 10, the electrical contact material 1, 2 can be favorably used in a contact, a terminal and a connector. Such a contact is a contact prepared using the electrical contact material 1, 2, such a terminal is a terminal prepared using the electrical contact material 1, 2, and such a connector is a connector prepared using the electrical contact material 1, 2.

Next, a production method of the electrical contact material 1, 2 will be explained.

First, a silver-containing layer is formed on at least part of the surface of a substrate having electroconductivity by a plating method or the like. Next, the substrate provided with the silver-containing layer on the surface is rolled. The electrical contact material 1 can be produced in this way.

In addition, an intermediate layer is formed on at least part of the surface of a substrate having electroconductivity by a plating method or the like. Next, a silver-containing layer is formed on the intermediate layer by a plating method or the like. Next, the substrate provided with the intermediate layer and the silver-containing layer is rolled. The electrical contact material 2 can be produced in this way.

For the plating conditions of the silver-containing layer, it is possible to further raise the internal stress of the silver-containing layer, from many crystal grains with different crystal orientation growing, and the difference in crystal orientation becoming greater, by setting the current density to 5 A/dm² or more and 10 A/dm² or less, and setting the bath temperature (solution temperature) to 25° C. or higher to prioritize nucleation. By controlling the current density and the temperature to the above ranges, it is possible to control the strain amount in the silver-containing layer. Even if the temperature is 25° C. or higher, when the current density is less than 5 A/dm², the crystal grains become coarse, the crystal grains of different crystal orientation become scarce, and the strain amount in the silver-containing layer becomes small, whereby it is not possible to satisfy the required wear resistance in a contact, a terminal and a connector. In addition, even if the temperature is 25° C. or higher, when the current density exceeds 10 A/dm², by the fine crystals becoming excessive, the crystal grains of different crystal orientation become great, and surface hardness is too high, whereby bending workability worsens.

In addition, the processing rate of the rolling has a lower limit value of 20% or more, and preferably 25% or more, and an upper limit value of 30% or less. If the processing rate is 20% or more, the amount of strain in the silver-containing layer is increased and the wear resistance can be improved. If the processing rate is 30% or less, it is possible to suppress a decline in bending workability due to the strain amount in the silver-containing layer becoming excessive. The processing rate of the rolling is a percentage dividing the difference between the cross-sectional area of a sample prior to the rolling and the cross-sectional area of the sample after the rolling by the cross-sectional area of the sample prior to the rolling.

In addition, thermal treatment at 300° C. to 600° C. for 5 to 60 seconds is conducted, after forming the silver-containing layer and before performing the rolling. By this thermal treatment, it is possible to unify the strain introduced by plating. By performing the thermal treatment in the above-mentioned ranges, it is possible to control the average CI value of the silver-containing layer to 0.6 or more by releasing the strain in the crystal grains. In addition, by releasing the strain in the crystal grains by the thermal treatment, the strain in the silver-containing layer can abundantly concentrate at the crystal grain boundary. In addition, the favorability of crystallinity improves due to the progress of alloying by the thermal treatment. As a result thereof, control of the CI value and the IQ value to within the predetermined ranges improves. For the thermal treatment, if at least one of the thermal treatment temperature less than 300° C. and the thermal treatment time less than 5 seconds, it is not possible to sufficiently release the strain in the crystal grains, and it is not possible to concentrate the strain to the vicinity of the grain boundary; therefore, the average CI value becomes less than 0.6. For the thermal treatment, even if at least one of the thermal treatment temperature exceeding 600° C. and the thermal treatment time exceeding 60 seconds, the average CI value similarly comes to exceed 0.6, and further, the thermal treatment is excessive and the material strength declines, and when using in a contact, a terminal or a connector, it is not possible to maintain sufficient strength.

In addition, in the case of producing the electrical contact material 1, 2 provided with the silver-containing layer 20 including the second element, the silver-containing layer including the second element may be formed directly by a plating method or the like using a plating bath containing silver-containing component and second element component in the above way. In addition, as another formation method, the silver-containing layer including the second element may be formed by performing a heat treatment after alternately forming the silver-containing layer and second element layer by a plating method or the like. The processing rate of the rolling in this case is preferably 20% or more and 30% or less from the viewpoint of the same aspects of the above. In addition, such heat treatment in this case may be substituted by the above-mentioned thermal treatment conducted after forming the silver-containing layer and before performing the rolling.

According to the above explained embodiment, by focusing on the strain amount in the silver-containing layer provided on the surface of the electroconductive substrate, and controlling the CI value of the silver-containing layer, it is possible to obtain the electrical contact material having superior wear resistance which is hardly influenced by the substrate properties.

Although an embodiment has been explained above, the present invention is not to be limited to the above embodiment, and includes all aspects encompassed by the gist of the present disclosure and scope of claims, and various modifications are possible within the scope of the present disclosure.

### EXAMPLES

Next, Examples and Comparative Examples will be explained; however, the present invention is not to be limited to these Examples.

### Examples 1 to 2 and 17

For the substrate (EFTEC-550T, 80% IACS, manufactured by Furukawa Electric), after electrolytic degreasing was performed, acid cleaning was performed. Subsequently, a silver-containing layer was formed on the substrate surface by a plating method (current density: 10 A/dm²) with an alkaline cyanide silver bath at the bath temperature of 25° C. (50 g/L silver cyanide, 100 g/L potassium cyanide), then heat treatment was performed at 300° C. to 600° C. for 5 seconds to 60 seconds. Next, by performing rolling at the processing rate shown in Table 1, the electrical contact material including the silver-containing layer (pure silver layer) shown in Table 1 was produced.

### Examples 3, 10, 11, 18, 25 and 26

For the substrate (EFTEC-550T, 80% IACS, manufactured by Furukawa Electric), after electrolytic degreasing was performed, acid cleaning was performed. Subsequently, a silver-containing layer was formed on the substrate surface by a plating method (current density: 10 A/dm²) with an alkaline cyanide silver bath at the bath temperature of 25° C. (50 g/L silver cyanide, 100 g/L potassium cyanide), followed by forming a tin layer by a plating method (current density: 10 A/dm²) with a sulfuric acid bath at the bath temperature of 25° C. (80 g/L tin sulfate, 80 g/L sulfuric acid), then heat treatment was performed at 300° C. to 600° C. for 5 seconds to 60 seconds. Next, by performing rolling at the processing rate shown in Table 1, the electrical contact material including the silver-containing layer (silver alloy layer) shown in Table 1 was produced.

### Comparative Examples 49 and 57

For the substrate (EFTEC-550T, 80% IACS, manufactured by Furukawa Electric), after electrolytic degreasing was performed, acid cleaning was performed. Subsequently, a silver-containing layer was formed on the substrate surface by a plating method (current density: 10 A/dm²) with an alkaline cyanide silver bath at the bath temperature of 25° C. (50 g/L silver cyanide, 100 g/L potassium cyanide), followed by forming a tin layer by a plating method (current density: 10 A/dm²) with a sulfuric acid bath at the bath temperature of 25° C. (80 g/L tin sulfate, 80 g/L sulfuric acid), then heat treatment was performed at less than 300° C. or higher than 600° C. for less than 5 seconds. Next, by performing rolling at the processing rate shown in Table 2, the electrical contact material including the silver-containing layer (silver alloy layer) shown in Table 2 was produced.

### Examples 4, 7 and 29

For the substrate (EFTEC-550T, 80% IACS, manufactured by Furukawa Electric), after electrolytic degreasing was performed, acid cleaning was performed. Subsequently, a silver-containing layer including the second element was formed on the substrate surface by a plating method (current density: 5 to 10 A/dm²) with an alkaline cyanide silver bath at the bath temperature of 25° C. (50 to 100 g/L silver cyanide, 100 to 200 g/L potassium cyanide, 10 g/L zinc chloride (Example 4), 12 g/L copper chloride dihydride (Example 7), 10 g/L nickel chloride (Example 29)), then heat treatment was performed at 300° C. to 600° C. for 5 seconds to 60 seconds. Next, by performing rolling at the processing rate shown in Table 1, the electrical contact material including the silver-containing layer (silver alloy layer) shown in Table 1 was produced.

### Comparative Examples 51, 55, 59 and 63

For the substrate (EFTEC-550T, 80% IACS, manufactured by Furukawa Electric), after electrolytic degreasing was performed, acid cleaning was performed. Subsequently, a silver-containing layer including the second element was formed on the substrate surface by a plating method (current density: 5 to 10 A/dm²) with an alkaline cyanide silver bath at the bath temperature of 25° C. (50 to 100 g/L silver cyanide, 100 to 200 g/L potassium cyanide, 10 g/L cobalt chloride (Comparative Examples 51 and 59), 12 g/L copper chloride dihydride (Comparative Examples 55 and 63)), then heat treatment was performed at less than 300° C. or higher than 600° C. for less than 5 seconds. Next, by performing rolling at the processing rate shown in Table 2, the electrical contact material including the silver-containing layer (silver alloy layer) shown in Table 2 was produced.

### Examples 5 and 28

For the substrate (EFTEC-550T, 80% IACS, manufactured by Furukawa Electric), after electrolytic degreasing was performed, acid cleaning was performed. Subsequently, an intermediate layer was formed on the substrate surface by a plating method (current density: 10 A/dm²) with a nickel plating bath at the bath temperature of 55° C. (500 g/L nickel sulfate hexahydrate, 30 g/L nickel chloride, 30 g/L boric acid), then a silver-containing layer including the second element was formed on the intermediate layer surface by a plating method (current density: 5 to 10 A/dm²) with an alkaline cyanide silver bath at the bath temperature of 25° C. (50 to 100 g/L silver cyanide, 100 to 200 g/L potassium cyanide, 15 g/L indium trichloride), then heat treatment was performed at 300° C. to 600° C. for 5 seconds to 60 seconds. Next, by performing rolling at the processing rate shown in Table 1, the electrical contact material including the silver-containing layer (silver alloy layer) and the intermediate layer (pure nickel layer) shown in Table 1 was produced.

### Comparative Examples 3, 11, 19, 27, 35 and 44

For the substrate (EFTEC-550T, 80% IACS, manufactured by Furukawa Electric), after electrolytic degreasing was performed, acid cleaning was performed. Subsequently, an intermediate layer was formed on the substrate surface by a plating method (current density: 10 A/dm²) with a nickel-phosphorus electrolytic bath at the bath temperature of 55° C. (500 g/L nickel sulfate hexahydrate, 30 g/L nickel chloride hexahydrate, 30 g/L boric acid, 16 g/L phosphonic acid), then a silver-containing layer including the second element was formed on the intermediate layer surface by a plating method (current density: 5 to 10 A/dm²) with an alkaline cyanide silver bath at the bath temperature of 25° C. (50 to 100 g/L silver cyanide, 100 to 200 g/L potassium cyanide, 15 g/L indium trichloride), then heat treatment was performed at less than 300° C. or higher than 600° C. for less than 5 seconds. Next, by performing rolling at the processing rate shown in Table 2, the electrical contact material including the silver-containing layer (silver alloy layer) and the intermediate layer (nickel alloy layer) shown in Table 2 was produced.

### Examples 6, 8, 9, 12, 13, 15, 16, 20, 21, 23, 24, 27, 30 and 31

For the substrate (EFTEC-550T, 80% IACS, manufactured by Furukawa Electric), after electrolytic degreasing was performed, acid cleaning was performed. Subsequently, an intermediate layer was formed on the substrate surface by a plating method (current density: 15 A/dm²) with a nickel plating bath at the bath temperature of 55° C. (500 g/L nickel sulfate hexahydrate, 30 g/L nickel chloride, 30 g/L boric acid) (Examples 12, 13, 20, 21 and 27) or a nickel-phosphorus electrolytic bath at the bath temperature of 55° C. (500 g/L nickel sulfate hexahydrate, 30 g/L nickel chloride hexahydrate, 30 g/L boric acid, 16 g/L phosphonic acid) (Examples 6, 8, 9, 15, 16, 23, 24, 30 and 31), then a silver-containing layer including the second element was formed on the intermediate layer surface by a plating method (current density: 5 to 10 A/dm²) with an alkaline cyanide silver bath at the bath temperature of 25° C. (50 to 100 g/L silver cyanide, 100 to 200 g/L potassium cyanide, 10 g/L nickel chloride (Examples 6, 15 and 23), 2.2 mg/L potassium selenocyanate (Examples 8 and 31), 12 g/L antimony trichloride (Examples 9 and 20), 10 g/L cobalt chloride (Example 12), 10 g/L zinc chloride (Examples 13, 21 and 27), 12 g/L copper chloride dihydride (Examples 16, 24 and 30)), then heat treatment was performed at 300° C. to 600° C. for 5 seconds to 60 seconds. Next, by performing rolling at the processing rate shown in Table 1, the electrical contact material including the silver-containing layer (silver alloy layer) and the intermediate layer (pure nickel layer or nickel alloy layer) shown in Table 1 was produced.

### Comparative Examples 2, 4 to 8, 10, 12 to 16, 18, 20 to 24, 26, 28 to 32, 34, 36, 38 to 40, 42, 43, 46 to 48, 50, 52, 54, 56, 58, 60, 62 and 64

For the substrate (EFTEC-550T, 80% IACS, manufactured by Furukawa Electric), after electrolytic degreasing was performed, acid cleaning was performed. Subsequently, an intermediate layer was formed on the substrate surface by a plating method (current density: 15 A/dm²) with a nickel plating bath at the bath temperature of 55° C. (500 g/L nickel sulfate hexahydrate, 30 g/L nickel chloride, 30 g/L boric acid) (Comparative Examples 2, 5, 6, 10, 13, 14, 18, 21, 22, 26, 29, 30, 34, 38, 42, 46, 50, 54, 58 and 62) or a nickel-phosphorus electrolytic bath at the bath temperature of 55° C. (500 g/L nickel sulfate hexahydrate, 30 g/L nickel chloride hexahydrate, 30 g/L boric acid, 16 g/L phosphonic acid) (Comparative Examples 4, 7, 8, 12, 15, 16, 20, 23, 24, 28, 31, 32, 36, 39, 40, 43, 47, 48, 52, 56, 60 and 64), then a silver-containing layer including the second element was formed on the intermediate layer surface by a plating method (current density: 5 to 10 A/dm²) with an alkaline cyanide silver bath at the bath temperature of 25° C. (50 to 100 g/L silver cyanide, 100 to 200 g/L potassium cyanide, 10 g/L zinc chloride (Comparative Examples 2, 10, 18, 26, 34, 43, 52 and 60), 10 g/L nickel chloride (Comparative Examples 4, 12, 20, 28, 36, 46, 54 and 62), 12 g/L copper chloride dihydride (Comparative Examples 5, 13, 21, 29, 38 and 47), 2.2 mg/L potassium selenocyanate (Comparative Examples 6, 14, 22, 30, 39, 48, 56 and 64), 12 g/L antimony trichloride (Comparative Examples 7, 15, 23, 31, 40, 50 and 58), 10 g/L cobalt chloride (Comparative Example 8, 16, 24, 32 and 42)), then heat treatment was performed at less than 300° C. or higher than 600° C. for less than 5 seconds. Next, by performing rolling at the processing rate shown in Table 2, the electrical contact material including the silver-containing layer (silver alloy layer) and the intermediate layer (pure nickel layer or nickel alloy layer) shown in Table 2 was produced.

### Examples 14 and 22

For the substrate (EFTEC-550T, 80% IACS, manufactured by Furukawa Electric), after electrolytic degreasing was performed, acid cleaning was performed. Subsequently, a silver-containing layer including the second element was formed on the substrate surface by a plating method (current density: 5 to 10 A/dm²) with an alkaline cyanide silver bath at the bath temperature of 25° C. (50 to 100 g/L silver cyanide, 100 to 200 g/L potassium cyanide, 15 g/L indium trichloride), then heat treatment was performed at 300° C. to 600° C. for 5 seconds to 60 seconds. Next, by performing rolling at the processing rate shown in Table 1, the electrical contact material including the silver-containing layer (silver alloy layer) shown in Table 1 was produced.

### Comparative Examples 53 and 61

For the substrate (EFTEC-550T, 80% IACS, manufactured by Furukawa Electric), after electrolytic degreasing was performed, acid cleaning was performed. Subsequently, a silver-containing layer including the second element was formed on the substrate surface by a plating method (current density: 5 to 10 A/dm²) with an alkaline cyanide silver bath at the bath temperature of 25° C. (50 to 100 g/L silver cyanide, 100 to 200 g/L potassium cyanide, 15 g/L indium trichloride), then heat treatment was performed at less than 300° C. or higher than 600° C. for less than 5 seconds. Next, by performing rolling at the processing rate shown in Table 2, the electrical contact material including the silver-containing layer (silver alloy layer) shown in Table 2 was produced.

### Example 19

For the substrate (EFTEC-550T, 80% IACS, manufactured by Furukawa Electric), after electrolytic degreasing was performed, acid cleaning was performed. Subsequently, a silver-containing layer including the second element was formed on the substrate surface by a plating method (current density: 10 A/dm²) with an alkaline cyanide silver bath at the bath temperature of 25° C. (100 g/L silver cyanide, 200 g/L potassium cyanide, 2.2 mg/L potassium selenocyanate), then heat treatment was performed at 300° C. to 600° C. for 5 seconds to 60 seconds. Next, by performing rolling at the processing rate shown in Table 1, the electrical contact material including the silver-containing layer (silver alloy layer) shown in Table 1 was produced.

### Comparative Examples 1, 9, 17, 25, 33, 37, 41 and 45

For the substrate (EFTEC-550T, 80% IACS, manufactured by Furukawa Electric), after electrolytic degreasing was performed, acid cleaning was performed. Subsequently, an intermediate layer was formed on the substrate surface by a plating method (current density: 15 A/dm²) with a nickel plating bath at the bath temperature of 55° C. (500 g/L nickel sulfate hexahydrate, 30 g/L nickel chloride, 30 g/L boric acid), then a silver-containing layer was formed on the intermediate layer surface by a plating method (current density: 10 A/dm²) with an alkaline cyanide silver bath at the bath temperature of 25° C. (50 g/L silver cyanide, 100 g/L potassium cyanide), followed by forming a tin layer by a plating method (current density: 10 A/dm²) with a sulfuric acid bath at the bath temperature of 25° C. (80 g/L tin sulfate, 80 g/L sulfuric acid), then heat treatment was performed at less than 300° C. or higher than 600° C. for less than 5 seconds. Next, by performing rolling at the processing rate shown in Table 2, the electrical contact material including the silver-containing layer (silver alloy layer) and the intermediate layer (pure nickel layer) shown in Table 2 was produced.

### (Measurement and Evaluation)

For the electrical contact material obtained in the above Examples and Comparative Examples, the following measurements and evaluation were performed. The results are shown in Table 3-4.

### [1] Average CI Value and Average IQ Value

The CI value and the IQ value were obtained from crystal orientation analysis data calculated using analysis software (OIM Analysis produced by TSL Solutions) from the crystal orientation data measured continuously using EBSD detector (OIM 5.0 HIKARI produced by TSL Solutions) belonging to a high-resolution scanning analytical electron microscope (JSM-7001FA manufactured by JEOL Ltd.).

Using a cross section polisher (manufactured by JEOL Ltd.), a silver-containing layer surface as a measurement target on a surface was obtained by mirror polishing the cross section of the electrical contact material parallel to the rolling direction of the electroconductive substrate. The measurement magnification was set to 30000 times. The measurement by steps of 50 nm or less measurement intervals was conducted, the measurement points at which the CI value analyzed by the analysis software was 0.1 or less are eliminated, the boundary at which the misorientation between adjacent pixels is 5.000 or more was regarded as the grain boundary, to obtain the CI value and the IQ value of the silver-containing layer. This measurement was performed five times (measurement region of 5 different locations in same sample), and the average value thereof was calculated to obtain the average CI value and the average IQ value of the silver-containing layer.

### [2] Coefficient of Dynamic Friction

Bulging was performed on the electrical contact material, and a bulged material having a radius of curvature of 5 mm at the bulged part was obtained. On the surface on the silver-containing layer side of the bulged material, reciprocating sliding was performed 15 times with 5N contact load, 5 mm sliding distance and 100 mm/min sliding speed, using a friction wear tester Tribogear (Surface Property Tester Type: 14FW, manufactured by Shinto Scientific Co., Ltd.). The numerical value at the 15^{th} time sliding was defined as the coefficient of dynamic friction. The coefficient of dynamic friction was assigned the following ranking.
⊚: coefficient of dynamic friction was less than 0.3
∘: coefficient of dynamic friction was 0.3 or more and less than 0.5
x: coefficient of dynamic friction was 0.5 or more

### [3] Wear Resistance

On the surface on the silver-containing layer side of the electrical contact material, reciprocating sliding was performed 50 times with 4N contact load, 50 mm sliding distance and 100 mm/min sliding speed, using a friction wear tester Tribogear (Surface Property Tester Type: 14FW, manufactured by Shinto Scientific Co., Ltd.). The ratio of the depth from the reference plane (plane not reciprocally sliding) relative to the thickness of the silver-containing layer was measured with a laser roughness meter. The wear resistance was assigned the following ranking.
⊚: ratio of depth from reference plane relative to thickness of silver-containing layer was less than 1/10
∘: ratio of depth from reference plane relative to thickness of silver-containing layer was 1/10 or more and less than 1/5
x: ratio of depth from reference plane relative to thickness of silver-containing layer was 1/5 or more

### [4] Contact Resistance Value

The contact resistance value was measured 10 times with 20 mA energizing current and 1N load using an electrical contact simulator (manufactured by Yamasaki Seiki) on the surface on the silver-containing layer side of the electrical contact material, and a value averaging the obtained measurement values was defined as the contact resistance value of the electrical contact material. The contact resistance value was assigned the following ranking.
⊚: contact resistance value was less than 0.5 mΩ
∘: contact resistance value was 0.5 mΩ or more and less than 1.0 mΩ
x: contact resistance value was 1.0 mΩ or more

### [5] Heat Resistance

Under an air atmosphere, the electrical contact material was heated for 1000 hours at 150° C. After heating, the contact resistance value was measured 10 times with 20 mA energizing current and 1N load using an electrical contact simulator (manufactured by Yamasaki Seiki) on the surface on the silver-containing layer side of the electrical contact material, and a value averaging the obtained measurement values was defined as the contact resistance value of the electrical contact material. The heat resistance value was assigned the following ranking.
⊚: contact resistance value after heating was less than 1.0 mΩ
∘: contact resistance value after heating was 1.0 mΩ or more and less than 5.0 mΩ
x: contact resistance value after heating was 5.0 mΩ or more

### [6] Bending Workability

Based on the test method of JCBA-T307:2007 Japan Copper and Brass Association technical standards, five (n=5) test pieces of 10 mm width×30 mm length were collected from the electrical contact material so that the length direction of the test pieces were parallel to the rolling direction, the bending test was performed on each test piece with a bending angle of 90 degrees and R/t=1, and the presence of cracks was determined.
◯: 5 test pieces had tree of cracks
X: 1 or more test pieces had cracks

TABLE 1

| | | | | Total | Average | | Average | | | |
|---|---|---|---|---|---|---|---|---|---|---|
| | | | | concentration | thickness of | | thickness of | Processing | Thermal | Thermal |
| | Average | Average | | of second | silver-contain- | Inter- | intermediate | rate of | treatment | treatment |
| | CI | IQ | Second | element | ing layer | mediate | layer | rolling | temperature | time |
| | value | value | element | (at %) | (μm) | layer | (μm) | (%) | (° C.) | (s) |
| Example 1 | 0.6 | 900 | — | — | 0.1 | — | — | 20 | 300 | 10 |
| Example 2 | 0.6 | 1000 | — | — | 0.1 | — | — | 20 | 300 | 20 |
| Example 3 | 0.6 | 1000 | Sn | 3.0 | 0.1 | — | — | 20 | 300 | 5 |
| Example 4 | 0.6 | 1000 | Zn | 3.0 | 0.5 | — | — | 20 | 300 | 5 |
| Example 5 | 0.6 | 1000 | In | 3.0 | 0.5 | Ni | 0.01 | 20 | 300 | 5 |
| Example 6 | 0.6 | 1000 | Ni | 3.0 | 0.5 | Ni alloy | 3.00 | 30 | 300 | 5 |
| Example 7 | 0.6 | 1000 | Cu | 3.0 | 5.0 | — | — | 20 | 300 | 5 |
| Example 8 | 0.6 | 1000 | Se | 3.0 | 5.0 | Ni alloy | 0.01 | 20 | 300 | 5 |
| Example 9 | 0.6 | 1000 | Sb | 3.0 | 5.0 | Ni alloy | 3.00 | 30 | 300 | 5 |
| Example 10 | 0.6 | 1000 | Sn | 10.0 | 0.1 | — | — | 20 | 350 | 10 |
| Example 11 | 0.6 | 1000 | Sn | 10.0 | 0.5 | — | — | 20 | 400 | 10 |
| Example 12 | 0.6 | 1000 | Co | 10.0 | 0.5 | Ni | 0.01 | 20 | 300 | 5 |
| Example 13 | 0.6 | 1000 | Zn | 10.0 | 0.5 | Ni | 3.00 | 30 | 300 | 5 |
| Example 14 | 0.6 | 1000 | In | 10.0 | 5.0 | — | — | 20 | 400 | 5 |
| Example 15 | 0.6 | 1000 | Ni | 10.0 | 5.0 | Ni alloy | 0.01 | 20 | 300 | 5 |
| Example 16 | 0.6 | 1000 | Cu | 10.0 | 5.0 | Ni alloy | 3.00 | 30 | 300 | 5 |
| Example 17 | 0.6 | 2100 | — | — | 0.1 | — | — | 20 | 450 | 10 |
| Example 18 | 0.6 | 2100 | Sn | 3.0 | 0.1 | — | — | 20 | 500 | 10 |
| Example 19 | 0.6 | 2100 | Se | 3.0 | 0.5 | — | — | 20 | 350 | 5 |
| Example 20 | 0.6 | 2100 | Sb | 3.0 | 0.5 | Ni | 0.01 | 20 | 450 | 5 |
| Example 21 | 0.6 | 2100 | Zn | 3.0 | 0.5 | Ni | 3.00 | 30 | 500 | 5 |
| Example 22 | 0.6 | 2100 | In | 3.0 | 5.0 | — | — | 20 | 500 | 5 |
| Example 23 | 0.6 | 2100 | Ni | 3.0 | 5.0 | Ni alloy | 0.01 | 20 | 500 | 5 |
| Example 24 | 0.6 | 2100 | Cu | 3.0 | 5.0 | Ni alloy | 3.00 | 30 | 500 | 5 |
| Example 25 | 0.6 | 2100 | Sn | 10.0 | 0.1 | — | — | 20 | 300 | 20 |
| Example 26 | 0.6 | 2100 | Sn | 10.0 | 0.5 | — | — | 20 | 300 | 60 |
| Example 27 | 0.6 | 2100 | Zn | 10.0 | 0.5 | Ni | 0.01 | 20 | 400 | 5 |
| Example 28 | 0.6 | 2100 | In | 10.0 | 0.5 | Ni | 3.00 | 30 | 600 | 5 |
| Example 29 | 0.6 | 2100 | Ni | 10.0 | 5.0 | — | — | 20 | 300 | 5 |
| Example 30 | 0.6 | 2100 | Cu | 10.0 | 5.0 | Ni alloy | 0.01 | 20 | 500 | 5 |
| Example 31 | 0.6 | 2100 | Se | 10.0 | 5.0 | Ni alloy | 3.00 | 30 | 600 | 5 |

TABLE 2

| | | | | Total | Average | | Average | | | |
|---|---|---|---|---|---|---|---|---|---|---|
| | | | | concentration | thickness of | | thickness of | Processing | Thermal | Thermal |
| | Average | Average | | of second | silver-contain- | Inter- | intermediate | rate of | treatment | treatment |
| | CI | IQ | Second | element | ing layer | mediate | layer | rolling | temperature | time |
| | value | value | element | (at %) | (μm) | layer | (μm) | (%) | (° C.) | (s) |
| Comparative Example 1 | 0.4 | 1000 | Sn | 3.0 | 0.5 | Ni | 0.01 | 20 | 100 | 3 |
| Comparative Example 2 | 0.4 | 1000 | Zn | 3.0 | 0.5 | Ni | 3.00 | 30 | 200 | 3 |
| Comparative Example 3 | 0.4 | 1000 | In | 3.0 | 5.0 | Ni alloy | 0.01 | 20 | 100 | 3 |
| Comparative Example 4 | 0.4 | 1000 | Ni | 3.0 | 5.0 | Ni alloy | 3.00 | 30 | 200 | 3 |
| Comparative Example 5 | 0.4 | 1000 | Cu | 10.0 | 0.5 | Ni | 0.01 | 20 | 100 | 3 |
| Comparative Example 6 | 0.4 | 1000 | Se | 10.0 | 0.5 | Ni | 3.00 | 30 | 200 | 3 |
| Comparative Example 7 | 0.4 | 1000 | Sb | 10.0 | 5.0 | Ni alloy | 0.01 | 20 | 100 | 3 |
| Comparative Example 8 | 0.4 | 1000 | Co | 10.0 | 5.0 | Ni alloy | 3.00 | 30 | 200 | 3 |
| Comparative Example 9 | 0.4 | 2100 | Sn | 3.0 | 0.5 | Ni | 0.01 | 20 | 100 | 3 |
| Comparative Example 10 | 0.4 | 2100 | Zn | 3.0 | 0.5 | Ni | 3.00 | 30 | 200 | 3 |
| Comparative Example 11 | 0.4 | 2100 | In | 3.0 | 5.0 | Ni alloy | 0.01 | 20 | 100 | 3 |
| Comparative Example 12 | 0.4 | 2100 | Ni | 3.0 | 5.0 | Ni alloy | 3.00 | 30 | 200 | 3 |
| Comparative Example 13 | 0.4 | 2100 | Cu | 10.0 | 0.5 | Ni | 0.01 | 20 | 100 | 3 |
| Comparative Example 14 | 0.4 | 2100 | Se | 10.0 | 0.5 | Ni | 3.00 | 30 | 200 | 3 |
| Comparative Example 15 | 0.4 | 2100 | Sb | 10.0 | 5.0 | Ni alloy | 0.01 | 20 | 100 | 3 |
| Comparative Example 16 | 0.4 | 2100 | Co | 10.0 | 5.0 | Ni alloy | 3.00 | 30 | 200 | 3 |
| Comparative Example 17 | 0.4 | 900 | Sn | 3.0 | 0.5 | Ni | 0.01 | 20 | 100 | 3 |
| Comparative Example 18 | 0.4 | 900 | Zn | 3.0 | 0.5 | Ni | 3.00 | 30 | 200 | 3 |
| Comparative Example 19 | 0.4 | 900 | In | 3.0 | 5.0 | Ni alloy | 0.01 | 20 | 100 | 3 |
| Comparative Example 20 | 0.4 | 900 | Ni | 3.0 | 5.0 | Ni alloy | 3.00 | 30 | 200 | 3 |
| Comparative Example 21 | 0.4 | 900 | Cu | 10.0 | 0.5 | Ni | 0.01 | 20 | 100 | 3 |
| Comparative Example 22 | 0.4 | 900 | Se | 10.0 | 0.5 | Ni | 3.00 | 30 | 200 | 3 |
| Comparative Example 23 | 0.4 | 900 | Sb | 10.0 | 5.0 | Ni alloy | 0.01 | 20 | 100 | 3 |
| Comparative Example 24 | 0.4 | 900 | Co | 10.0 | 5.0 | Ni alloy | 3.00 | 30 | 200 | 3 |
| Comparative Example 25 | 0.4 | 2500 | Sn | 3.0 | 0.5 | Ni | 0.01 | 20 | 100 | 3 |
| Comparative Example 26 | 0.4 | 2500 | Zn | 3.0 | 0.5 | Ni | 3.00 | 30 | 200 | 3 |
| Comparative Example 27 | 0.4 | 2500 | In | 3.0 | 5.0 | Ni alloy | 0.01 | 20 | 100 | 3 |
| Comparative Example 28 | 0.4 | 2500 | Ni | 3.0 | 5.0 | Ni alloy | 3.00 | 30 | 200 | 3 |
| Comparative Example 29 | 0.4 | 2500 | Cu | 10.0 | 0.5 | Ni | 0.01 | 20 | 100 | 3 |
| Comparative Example 30 | 0.4 | 2500 | Se | 10.0 | 0.5 | Ni | 0.01 | 20 | 100 | 3 |
| Comparative Example 31 | 0.4 | 2500 | Sb | 10.0 | 5.0 | Ni alloy | 0.01 | 20 | 100 | 3 |
| Comparative Example 32 | 0.4 | 2500 | Co | 10.0 | 5.0 | Ni alloy | 0.01 | 20 | 100 | 3 |
| Comparative Example 33 | 0.4 | 1000 | Sn | 18.0 | 0.5 | Ni | 0.01 | 20 | 100 | 3 |
| Comparative Example 34 | 0.4 | 1000 | Zn | 18.0 | 0.5 | Ni | 3.00 | 30 | 200 | 3 |
| Comparative Example 35 | 0.4 | 1000 | In | 18.0 | 5.0 | Ni alloy | 0.01 | 20 | 100 | 3 |
| Comparative Example 36 | 0.4 | 1000 | Ni | 18.0 | 5.0 | Ni alloy | 3.00 | 30 | 200 | 3 |
| Comparative Example 37 | 0.4 | 2100 | Sn | 18.0 | 0.5 | Ni | 0.01 | 20 | 100 | 3 |
| Comparative Example 38 | 0.4 | 2100 | Cu | 18.0 | 0.5 | Ni | 3.00 | 30 | 200 | 3 |
| Comparative Example 39 | 0.4 | 2100 | Se | 18.0 | 5.0 | Ni alloy | 0.01 | 20 | 100 | 3 |
| Comparative Example 40 | 0.4 | 2100 | Sb | 18.0 | 5.0 | Ni alloy | 3.00 | 30 | 200 | 3 |
| Comparative Example 41 | 0.4 | 1000 | Sn | 3.0 | 0.1 | Ni | 0.01 | 20 | 100 | 3 |
| Comparative Example 42 | 0.4 | 1000 | Co | 3.0 | 0.1 | Ni | 3.00 | 30 | 200 | 3 |
| Comparative Example 43 | 0.4 | 1000 | Zn | 10.0 | 0.1 | Ni alloy | 0.01 | 20 | 100 | 3 |
| Comparative Example 44 | 0.4 | 1000 | In | 10.0 | 0.1 | Ni alloy | 3.00 | 30 | 200 | 3 |
| Comparative Example 45 | 0.4 | 2100 | Sn | 3.0 | 0.1 | Ni | 0.01 | 20 | 100 | 3 |
| Comparative Example 46 | 0.4 | 2100 | Ni | 3.0 | 0.1 | Ni | 3.00 | 30 | 200 | 3 |
| Comparative Example 47 | 0.4 | 2100 | Cu | 10.0 | 0.1 | Ni alloy | 0.01 | 20 | 100 | 3 |
| Comparative Example 48 | 0.4 | 2100 | Se | 10.0 | 0.1 | Ni alloy | 3.00 | 30 | 200 | 3 |
| Comparative Example 49 | 0.4 | 1000 | Sn | 3.0 | 0.5 | — | — | 20 | 100 | 3 |
| Comparative Example 50 | 0.4 | 1000 | Sb | 3.0 | 0.5 | Ni | 5.00 | 30 | 250 | 3 |
| Comparative Example 51 | 0.4 | 1000 | Co | 3.0 | 5.0 | — | — | 20 | 200 | 3 |
| Comparative Example 52 | 0.4 | 1000 | Zn | 3.0 | 5.0 | Ni alloy | 5.00 | 30 | 250 | 3 |
| Comparative Example 53 | 0.4 | 1000 | In | 10.0 | 0.5 | — | — | 20 | 100 | 3 |
| Comparative Example 54 | 0.4 | 1000 | Ni | 10.0 | 0.5 | Ni | 5.00 | 30 | 100 | 3 |
| Comparative Example 55 | 0.4 | 1000 | Cu | 10.0 | 5.0 | — | — | 20 | 200 | 3 |
| Comparative Example 56 | 0.4 | 1000 | Se | 10.0 | 5.0 | Ni alloy | 5.00 | 30 | 250 | 3 |
| Comparative Example 57 | 0.4 | 2100 | Sn | 3.0 | 0.5 | — | — | 20 | 200 | 3 |
| Comparative Example 58 | 0.4 | 2100 | Sb | 3.0 | 0.5 | Ni | 5.00 | 30 | 250 | 3 |
| Comparative Example 59 | 0.4 | 2100 | Co | 3.0 | 5.0 | — | — | 20 | 200 | 3 |
| Comparative Example 60 | 0.4 | 2100 | Zn | 3.0 | 5.0 | Ni alloy | 5.00 | 30 | 250 | 3 |
| Comparative Example 61 | 0.4 | 2100 | In | 10.0 | 0.5 | — | — | 20 | 100 | 3 |
| Comparative Example 62 | 0.4 | 2100 | Ni | 10.0 | 0.5 | Ni | 5.00 | 30 | 250 | 3 |
| Comparative Example 63 | 0.4 | 2100 | Cu | 10.0 | 5.0 | — | — | 20 | 200 | 3 |
| Comparative Example 64 | 0.4 | 2100 | Se | 10.0 | 5.0 | Ni alloy | 5.00 | 30 | 250 | 3 |

TABLE 3

| | Coefficient | | Contact | | |
|---|---|---|---|---|---|
| | of dynamic | Wear | resistance | Heat | Bending |
| | friction | resistance | value | resistance | workability |
| Example 1 | ◯ | ◯ | ◯ | ◯ | ◯ |
| Example 2 | ◯ | ◯ | ◯ | ◯ | ◯ |
| Example 3 | ⊚ | ⊚ | ◯ | ◯ | ◯ |
| Example 4 | ⊚ | ⊚ | ◯ | ◯ | ◯ |
| Example 5 | ⊚ | ⊚ | ◯ | ⊚ | ◯ |
| Example 6 | ⊚ | ⊚ | ◯ | ⊚ | ◯ |
| Example 7 | ⊚ | ⊚ | ⊚ | ◯ | ◯ |
| Example 8 | ⊚ | ⊚ | ⊚ | ⊚ | ◯ |
| Example 9 | ⊚ | ⊚ | ⊚ | ⊚ | ◯ |
| Example 10 | ⊚ | ⊚ | ◯ | ◯ | ◯ |
| Example 11 | ⊚ | ⊚ | ◯ | ◯ | ◯ |
| Example 12 | ⊚ | ⊚ | ◯ | ⊚ | ◯ |
| Example 13 | ⊚ | ⊚ | ◯ | ⊚ | ◯ |
| Example 14 | ⊚ | ⊚ | ⊚ | ◯ | ◯ |
| Example 15 | ⊚ | ⊚ | ⊚ | ⊚ | ◯ |
| Example 16 | ⊚ | ⊚ | ⊚ | ⊚ | ◯ |
| Example 17 | ◯ | ◯ | ◯ | ◯ | ◯ |
| Example 18 | ⊚ | ⊚ | ◯ | ◯ | ◯ |
| Example 19 | ⊚ | ⊚ | ◯ | ◯ | ◯ |
| Example 20 | ⊚ | ⊚ | ◯ | ⊚ | ◯ |
| Example 21 | ⊚ | ⊚ | ◯ | ⊚ | ◯ |
| Example 22 | ⊚ | ⊚ | ⊚ | ◯ | ◯ |
| Example 23 | ⊚ | ⊚ | ⊚ | ⊚ | ◯ |
| Example 24 | ⊚ | ⊚ | ⊚ | ⊚ | ◯ |
| Example 25 | ⊚ | ⊚ | ◯ | ◯ | ◯ |
| Example 26 | ⊚ | ⊚ | ◯ | ◯ | ◯ |
| Example 27 | ⊚ | ⊚ | ◯ | ⊚ | ◯ |
| Example 28 | ⊚ | ⊚ | ◯ | ⊚ | ◯ |
| Example 29 | ⊚ | ⊚ | ⊚ | ◯ | ◯ |
| Example 30 | ⊚ | ⊚ | ⊚ | ⊚ | ◯ |
| Example 31 | ⊚ | ⊚ | ⊚ | ⊚ | ◯ |

TABLE 4

| | Coefficient | | Contact | | |
|---|---|---|---|---|---|
| | of dynamic | Wear | resistance | Heat | Bending |
| | friction | resistance | value | resistance | workability |
| Comparative Example 1 | X | X | ◯ | ◯ | ◯ |
| Comparative Example 2 | X | X | ◯ | ⊚ | ◯ |
| Comparative Example 3 | X | X | ⊚ | ◯ | ◯ |
| Comparative Example 4 | X | X | ⊚ | ⊚ | ◯ |
| Comparative Example 5 | X | X | ◯ | ◯ | ◯ |
| Comparative Example 6 | X | X | ◯ | ⊚ | ◯ |
| Comparative Example 7 | X | X | ⊚ | ◯ | ◯ |
| Comparative Example 8 | X | X | ⊚ | ⊚ | ◯ |
| Comparative Example 9 | X | X | ◯ | ◯ | ◯ |
| Comparative Example 10 | X | X | ◯ | ⊚ | ◯ |
| Comparative Example 11 | X | X | ⊚ | ◯ | ◯ |
| Comparative Example 12 | X | X | ⊚ | ⊚ | ◯ |
| Comparative Example 13 | X | X | ◯ | ◯ | ◯ |
| Comparative Example 14 | X | X | ◯ | ⊚ | ◯ |
| Comparative Example 15 | X | X | ⊚ | ◯ | ◯ |
| Comparative Example 16 | X | X | ⊚ | ⊚ | ◯ |
| Comparative Example 17 | X | X | ◯ | ◯ | ◯ |
| Comparative Example 18 | X | X | ◯ | ⊚ | ◯ |
| Comparative Example 19 | X | X | ⊚ | ◯ | ◯ |
| Comparative Example 20 | X | X | ⊚ | ⊚ | ◯ |
| Comparative Example 21 | X | X | ◯ | ◯ | ◯ |
| Comparative Example 22 | X | X | ◯ | ⊚ | ◯ |
| Comparative Example 23 | X | X | ⊚ | ◯ | ◯ |
| Comparative Example 24 | X | X | ⊚ | ⊚ | ◯ |
| Comparative Example 25 | X | X | ◯ | ◯ | ◯ |
| Comparative Example 26 | X | X | ◯ | ⊚ | ◯ |
| Comparative Example 27 | X | X | ⊚ | ◯ | ◯ |
| Comparative Example 28 | X | X | ⊚ | ⊚ | ◯ |
| Comparative Example 29 | X | X | ◯ | ◯ | ◯ |
| Comparative Example 30 | X | X | ◯ | ⊚ | ◯ |
| Comparative Example 31 | X | X | ⊚ | ◯ | ◯ |
| Comparative Example 32 | X | X | ⊚ | ⊚ | ◯ |
| Comparative Example 33 | X | X | X | ◯ | ◯ |
| Comparative Example 34 | X | X | X | ⊚ | ◯ |
| Comparative Example 35 | X | X | X | ◯ | ◯ |
| Comparative Example 36 | X | X | X | ⊚ | ◯ |
| Comparative Example 37 | X | X | X | ◯ | ◯ |
| Comparative Example 38 | X | X | X | ⊚ | ◯ |
| Comparative Example 39 | X | X | X | ◯ | ◯ |
| Comparative Example 40 | X | X | X | ⊚ | ◯ |
| Comparative Example 41 | X | X | X | ◯ | ◯ |
| Comparative Example 42 | X | X | X | ⊚ | ◯ |
| Comparative Example 43 | X | X | X | ◯ | ◯ |
| Comparative Example 44 | X | X | X | ⊚ | ◯ |
| Comparative Example 45 | X | X | X | ◯ | ◯ |
| Comparative Example 46 | X | X | X | ⊚ | ◯ |
| Comparative Example 47 | X | X | X | ◯ | ◯ |
| Comparative Example 48 | X | X | X | ⊚ | ◯ |
| Comparative Example 49 | X | X | ◯ | X | ◯ |
| Comparative Example 50 | X | X | ◯ | ⊚ | X |
| Comparative Example 51 | X | X | ⊚ | X | ◯ |
| Comparative Example 52 | X | X | ⊚ | ⊚ | X |
| Comparative Example 53 | X | X | ◯ | X | ◯ |
| Comparative Example 54 | X | X | ◯ | ⊚ | X |
| Comparative Example 55 | X | X | ⊚ | X | ◯ |
| Comparative Example 56 | X | X | ⊚ | ⊚ | X |
| Comparative Example 57 | X | X | ◯ | X | ◯ |
| Comparative Example 58 | X | X | ◯ | ⊚ | X |
| Comparative Example 59 | X | X | ⊚ | X | ◯ |
| Comparative Example 60 | X | X | ⊚ | ⊚ | X |
| Comparative Example 61 | X | X | ◯ | X | ◯ |
| Comparative Example 62 | X | X | ◯ | ⊚ | X |
| Comparative Example 63 | X | X | ⊚ | X | ◯ |
| Comparative Example 64 | X | X | ⊚ | ⊚ | X |

As shown in Tables 1 to 4, in Examples 1 to 31, since the average CI value of the silver-containing layer was 0.6 or more, the wear resistance of the electrical contact material was favorable without being influenced by the properties of the electroconductive substrate. On the other hand, in Comparative Examples 1 to 64, since the silver-containing layer was outside the range of the average CI value being 0.6 or more, the wear resistance of the electrical contact material was inferior.

### EXPLANATION OF REFERENCE NUMERALS

1, 2 electrical contact material
10 electroconductive substrate
20 silver-containing layer
30 intermediate layer

1. An electrical contact material comprising:
an electroconductive substrate; and
a silver-containing layer including silver provided to at least part of a surface of the electroconductive substrate,
wherein an average CI value of the silver-containing layer is 0.6 or more in a cross section of the electrical contact material.

2. The electrical contact material according to claim 1, wherein an average IQ value of the silver-containing layer is 1000 or more and 2100 or less in the cross section of the electrical contact material.

3. The electrical contact material according to claim 1, wherein the silver-containing layer includes at least one element selected from the group consisting of Sn, Zn, In, Ni, Cu, Se, Sb and Co.

4. The electrical contact material according to claim 1, wherein the silver-containing layer includes a total of less than 15.0 at % of at least one element selected from the group consisting of Sn, Zn, In, Ni, Cu, Se, Sb and Co.

5. The electrical contact material according to claim 1, wherein an average thickness of the silver-containing layer is 0.5 μm or more and 5.0 μm or less.

6. The electrical contact material according to claim 1, further comprising an intermediate layer consisting of nickel or nickel alloy between the electroconductive substrate and the silver-containing layer.

7. The electrical contact material according to claim 6, wherein an average thickness of the intermediate layer is 0.01 μm or more and 3.00 μm or less.

8. A contact made using the electrical contact material according to claim 1.

9. A terminal made using the electrical contact material according to claim 1.

10. A connector made using the electrical contact material according to claim 1.

11. The electrical contact material according to claim 2, wherein the silver-containing layer includes at least one element selected from the group consisting of Sn, Zn, In, Ni, Cu, Se, Sb and Co.

12. The electrical contact material according to claim 2, wherein the silver-containing layer includes a total of less than 15.0 at % of at least one element selected from the group consisting of Sn, Zn, In, Ni, Cu, Se, Sb and Co.

13. The electrical contact material according to claim 2, wherein an average thickness of the silver-containing layer is 0.5 μm or more and 5.0 μm or less.

14. The electrical contact material according to claim 2, further comprising an intermediate layer consisting of nickel or nickel alloy between the electroconductive substrate and the silver-containing layer.

15. A contact made using the electrical contact material according to claim 2.

16. A terminal made using the electrical contact material according to claim 2.

17. A connector made using the electrical contact material according to claim 2.

18. The electrical contact material according to claim 3, wherein the silver-containing layer includes a total of less than 15.0 at % of at least one element selected from the group consisting of Sn, Zn, In, Ni, Cu, Se, Sb and Co.

19. The electrical contact material according to claim 3, wherein an average thickness of the silver-containing layer is 0.5 μm or more and 5.0 μm or less.

20. The electrical contact material according to claim 3, further comprising an intermediate layer consisting of nickel or nickel alloy between the electroconductive substrate and the silver-containing layer.
